(19) United States
(12) Patent Application Publication
(10) Pub. No.: US 2001/0012248 A1
(43) Pub. Date: Aug. 9, 2001

(54) SELECTIVE PLAYBACK DEVICE FOR RECORDING MEDIA

(76) Inventors: AKIHIRO YOSHIOKA, OSAKA (JP); MASANORI MOTOKI, NARA (JP); SHOUJI ARIKUMA, OSAKA (JP)

Correspondence Address: ARMSTRONG,WESTERMAN, HATTORI,, MCLELAND & NAUGHTON, LLP, 1725 K STREET, NW, SUITE 1000, WASHINGTON, DC, 20006, US

(21) Appl. No.: 09/077,292

(22) PCT Filed: Oct. 4, 1996
(86) PCT No.: PCT/JP96/02914

§ 371 Date: None

(30) Foreign Application Priority Data
Nov. 29, 1995 (JP) 7-311307

(51) Int. Cl. G11B 17/22; G11B 17/04; G11B 17/08

(52) U.S. Cl. 369/36; 369/178; 369/191

(57) ABSTRACT

A disk changer device for accommodating a plurality of recording medium disks such as CDs (compact disks) and selectively playing back the accommodated disks is improved in manipulability by being so adapted as to play back the disk selected when a disk select switch is manipulated with a front door closed, and to eject a disk tray carrying the selected disk when the select switch is manipulated with the front door opened.

### TECHNICAL FIELD

The present invention relates to selective playback devices for recording media such as disk changer devices for accommodating a plurality of disks such as CDs (compact disks) in the body of the device and selectively playing back the accommodated disks.

### BACKGROUND ART

In recent years, attention has been directed to so-called CD changers adapted to accommodate a plurality of disks in the body thereof for selectively playing back the disks. Various CD changers have been developed and made commercially available which are adapted to accommodate disks ranging from about 3 to more than 100 in number.

FIG. 4 shows an example of conventional CD changer. With reference to the drawing, indicated at 21 is the body of the device, which is provided on the front side thereof with a front door 22 movable for opening and closing in the directions of arrows B, a front door switch 23 to be manipulated for opening and closing the front door, and disk trays 24 each designed to place a disk thereon. As shown in the drawing, the disk trays 24 are six in number in this example and each movable into and out of the device body in the directions of arrows A.

Indicated at 22 is a disk loading/inject switch for moving the disk tray 24 in the direction of arrow A for loading or ejection, and at 25 are disk select switches for selecting the disk to be played back or ejected.

When desired one of the disks is to be played back, therefore, the disk is selected by manipulating the disk select switch 25 concerned and thereafter played back by manipulating a playback switch 27. When desired one of the disks is to be ejected, on the other hand, the front door 22 is first opened by manipulating the front door switch 23, the disk is then selected by manipulating the disk select switch 25 concerned and the disk tray carrying the desired disk is further moved forward to a projected position by manipulating the disk loading/eject switch 26.

Thus, the conventional CD changer requires the cumbersome procedure of manipulating two switches, i.e., the disk select switch 25 and the disk loading/eject switch 26, for loading or ejecting the disk, or manipulating two switches; i.e., the disk select switch 25 and the playback switch 27, for playing back the disk.

### DISCLOSURE OF THE INVENTION

The present invention provides a device which comprises a plurality of recording medium transport means movable between a first position where a recording medium can be placed on or delivered from the transport means and a second position where the recording medium is accommodated in a body of the device, recording medium playback means for playing back the recording medium placed on the transport means, recording medium select means for selecting the recording medium to be played back from among the recording media placed on the plurality of transport means respectively, covering means positioned in front of the plurality of transport means and movable between a first position where the transport means are covered therewith and a second position where the transport means are not covered therewith, position sensor means for detecting the first position and the second position of the covering means, and control means for playing back the recording medium selected by the select means when the covering means is in the first position and for moving the transport means carrying the recording medium selected by the select means to the first position when the covering means is in the second position. Thus, when the covering means is in its first position, a desired recording medium can be played back by manipulating the select means, while when the covering means is in its second position, a desired recording medium can be ejected by manipulating the select means. Accordingly, the invention contributes to a reduction in the number of manual switches, etc. and to an improvement in manipulability.

### BRIEF DESCRIPTION OF DRAWINGS

FIG. 1 is a view showing the appearance of a disk changer device of the invention;

FIG. 2 is a circuit block diagram showing the construction of the disk changer device of the invention;

FIG. 3 is a flow chart showing the operation of the disk changer device of the invention; and

FIG. 4 is a view showing the appearance of a conventional disk changer.

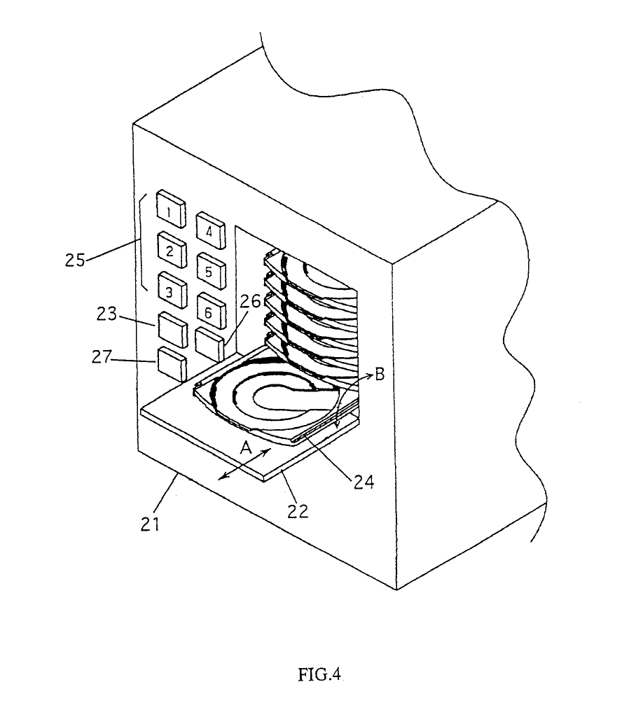

### BEST MODE FOR CARRYING OUT OF THE INVENTION

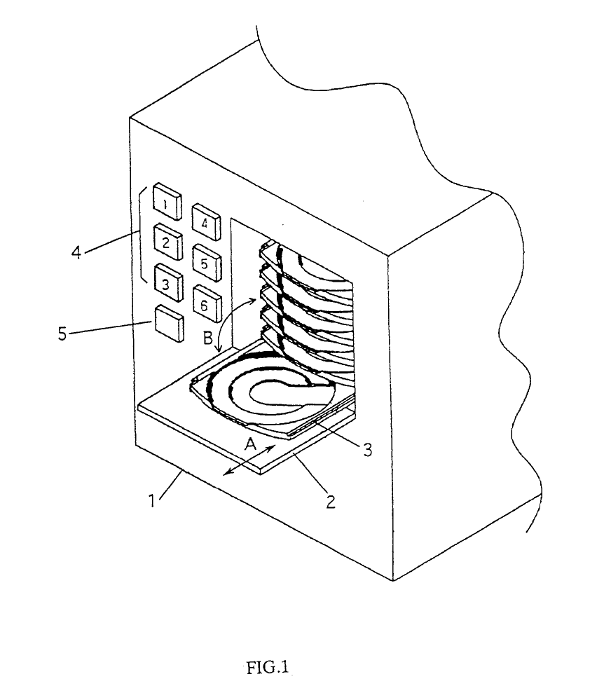

FIG. 1 shows the appearance of a CD changer embodying the invention. With reference to the drawing, indicated at 1 is the body of the device, which is provided on the front side thereof with a front door (covering means) 2 movable in the directions of arrows B for opening (second position) and closing (first position), a front door switch 5 to be manipulated for opening and closing the front door 2, and disk trays (recording medium transport means) 3 each designed to place a disk thereon. As shown in the drawing, the disk trays 3 are six in number in this embodiment and each movable in the directions of arrows A into the device body (to a second position) and out of the body (to a first position).

Indicated at 4 are disk select switches recording medium select means) for use in selecting the disk to be played back or ejected by a number. The invention is characterized in that when the disk select switch 4 bearing the number of desired one of the disks is manipulated for selection with the front door 2 closed, the selected disk is played back, and further that when the disk select switch 4 bearing the number of desired one of the disks is manipulated for selection with the front door 2 opened, the selected disk is ejected.

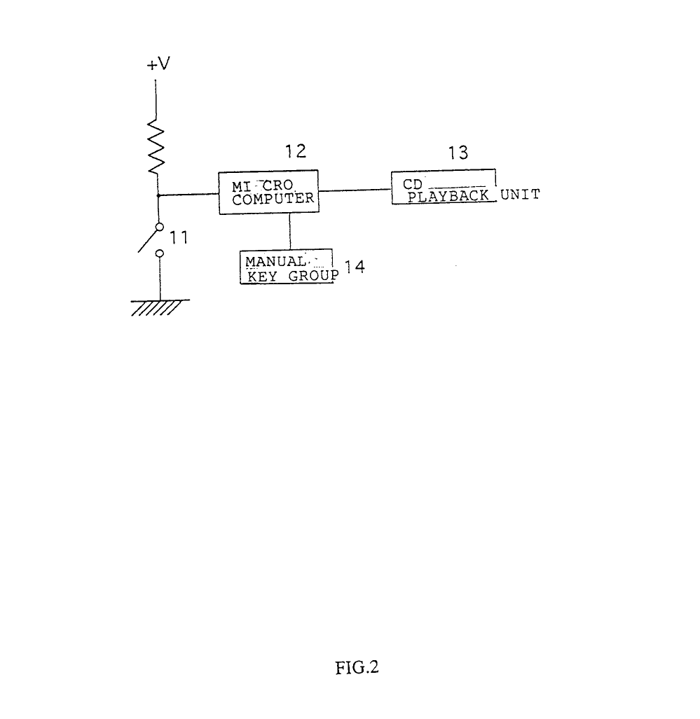

FIG. 2 is a circuit block diagram showing the construction of the CD charger of the invention. Indicated at 11 in this drawing is a front door sensor switch (sensor means) which is turned on or off by the opening or closing of the front door 2 shown in FIG. 1. The sensor switch is so adapted as to be on while the front door 2 is open, or off while the front door 2 is closed.

Next indicated at 12 is a microcomputer (control means) for controlling the operation of the device, at 13 a disk playback unit (recording medium playback means), and at 14 a group of manual keys including the disk select switches 4 and front door switch described above and unillustrated various manual switches.

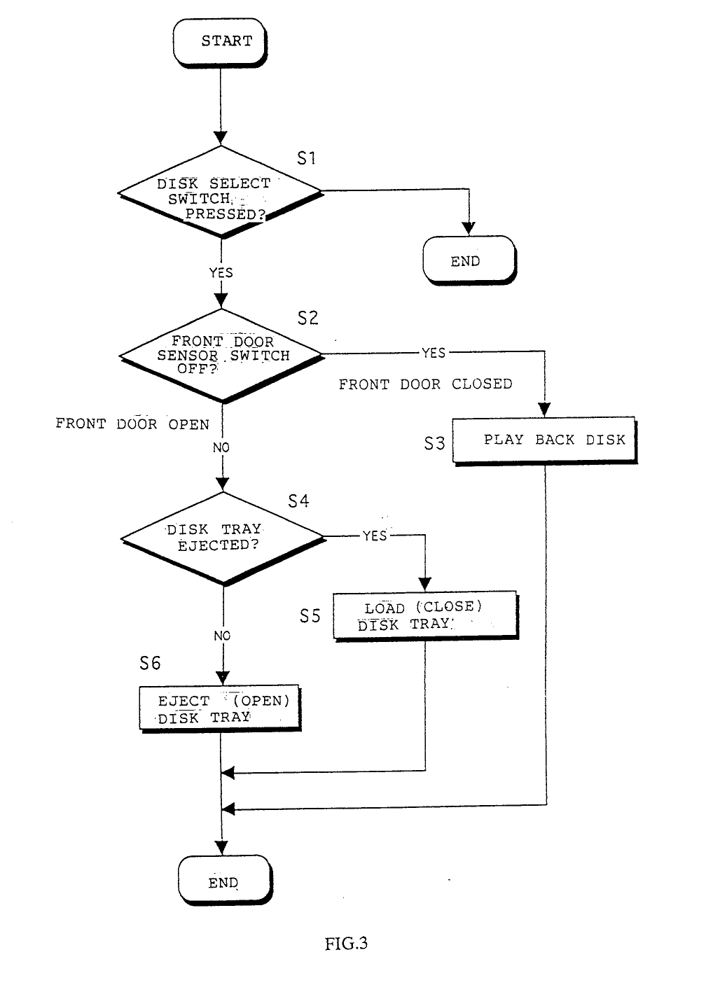

The operation of the CD changer of the invention will be described next with reference to the flow chart of FIG. 3. When one of the disk select switches 4 is manipulated by the user (S1), the microcomputer 12 checks whether the front door 2 is open or closed with reference to the state of the front door sensor switch 11 (S2).

When the sensor switch 11 is off, the microcomputer 12 recognizes that the front door 2 is closed, transfers the disk with the number selected by the disk select switch 4 from the disk tray to the CD playback unit 13 and thereafter plays back the disk (S3).

If the sensor switch 11 is found to be on in the step S2, the microcomputer 12 recognizes that the front door 2 is open and then checks whether one of the six disk trays is open in an ejected position (S4).

When the disk tray corresponding to the number selected by the disk select switch 4 is found open in the ejected position in this step, the microcomputer 12 moves the disk tray to a loaded position (i.e., closed position) (S5).

When the disk tray corresponding to the number selected by the disk select switch 4 is found to be in the loaded position (i.e., closed), the microcomputer 12 moves the disk tray to the ejected position (i.e., opened position).

Although the present embodiment is adapted to accommodate six disks, the same advantage as described above can be apparently obtained with a desired number of disks.

The device described above is adapted to effect an automatic change-over between the disk playback operation and the disk loading/eject operation in accordance with the opening-closing state of the front door merely by manipulating the disk select switch, the invention thus contributing to a reduction in the number of manual switches and to improved manipulability.

Industrial Applicability

In a selective playback device for recording media such as a disk changer device for accommodating a plurality of CDs (compact disks) or like disks in the body of the device and selectively playing back the accommodated disks, an automatic change-over between a disk playback operation and a disk loading/eject operation can be effected automatically in accordance with the opening-closing state of a front door merely by manipulating a disk select switch. The invention contributes to a reduction in the number of manual switches and to improved manipulability.

What is claimed is:

1. A selective playback device for recording media characterized in that the device comprises:
a plurality of recording medium transport means movable between a first position where the recording medium can be placed on or delivered from the transport means and a second position where the recording medium is accommodated in a body of the device,
recording medium playback means for playing back the recording medium placed on the transport means, recording medium select means for selecting the recording medium to be played back from among the recording media placed on the plurality of transport means respectively,
covering means positioned in front of the plurality of transport means and movable between a first position where the transport means are covered therewith and a second position where the transport means are not covered therewith,
position sensor means for detecting the first position and the second position of the covering means, and
control means for playing back the recording medium selected by the select means when the covering means is in the first position and for moving the transport means carrying the recording medium selected by the select means to the first position when the covering means is in the second position.
